(19) United States
(12) Patent Application Publication
(10) Pub. No.: US 2022/0380106 A1
(43) Pub. Date: Dec. 1, 2022

(54) Recycling Enhancement For Flexible Packaging

(71) Applicant: GreenChip Pty Ltd as trustee of The GreenChip Trust, Carlton (AU)

(72) Inventor: Anthony Peyton, Carlton (AU)

(21) Appl. No.: 17/362,523

(22) Filed: Jun. 29, 2021

(30) Foreign Application Priority Data
Jun. 1, 2021 (AU) 2021203555

(51) Int. Cl. B65D 75/54; B65D 33/00

(52) U.S. Cl. CPC B65D 75/54; B65D 33/004

(57) ABSTRACT

An adhesive web attachable to a part of a flexible package that is foldable or scrollable into a three-dimensional shape when substantially empty; said web being adapted to be deployed to enhance the ability of said package to remain in said three-dimensional shape; wherein said web is releasably adhesive to an outer surface of said package so that it lays flat on said surface; and wherein a first part of said web may be lifted from contact with said surface and reattached to a different part of said package.

### CROSS REFERENCES TO RELATED APPLICATION

This application claims the benefit of and priority to Australian Patent Application No. 2021203555, filed Jun. 1, 2021. The entire specification and figures of the above-referenced application are hereby incorporated, in their entirety by reference.

### TECHNICAL FIELD

The invention relates to the field of commercial flexible packaging, such as pouches made from polymer webbing. In particular, the invention relates to an enhancement for said packaging that improves its post-use ability to be separated from other waste for, e.g. recycling.

### BACKGROUND OF THE INVENTION

There is an increasing trend for the recycling of many materials. Used packaging, for food and other items, is a key opportunity to recover recyclable plastic materials such as those used in bottles, bags, cartons and some pouches.

The recycling of pouches, such as the stand-up pouches used primarily to package food items, which tend to flatten out as they are emptied, presents problems particularly in the sorting of such items from other waste materials.

Typically, in the separation process for a commingled or single stream collection system, three-dimensional plastic recyclable objects, such as plastic bottles and plastic trays, are sorted from two dimensional objects, such as sheets of paper, newspaper, etc. by using an inclined conveyor. As the recyclable material is transported up the inclined conveyor, the three-dimensional plastic objects, will tend to roll or fall down to the bottom of the conveyor. However, the two-dimensional flat plastic items, especially stand-up pouches, will stay on the conveyor and be transported along with other flat non-plastic items.

Therefore, it is desired to find some way to ensure that empty plastic pouches are more readily and reliably separable from other flat waste. Given the economics of such recovery operations, it is a requirement that this be done in a relatively robust and cost-effective manner.

Previously, there have been attempts made to solve this problem by improving the consumer's ability to roll, fold or otherwise shape such packages into a three-dimensional shape, such as by scrolling into a roll. U.S. Pat. No. 10,106,285 by Charter NEX Films, Inc. describes the addition of adhesive material to a stand-up pouch that the consumer can use after scrolling an empty pouch into a roll to hold the roll in place by taping over the edge of the pouch and connecting with the scrolled surface below.

However, the completely cylindrical shape envisaged in this prior art, especially for smaller pouches, does not sufficiently enhance to the ability or to separate the scrolled pouch from other materials in the typical separation processes employed in the recovery industries. Moreover, the prior art does not apply size limitations on the pouches, which is necessary to ensure the recovery in the sorting centre.

Accordingly, it is an object of the invention to provide a solution that ameliorates at least some of the problems associated with the prior art.

### SUMMARY OF THE INVENTION

An adhesive web attachable to a part of a flexible package that is both foldable and scrollable into a three-dimensional shape when substantially empty; said web being adapted to be deployed to enhance the ability of said package to remain in said three-dimensional shape; wherein said web is wholly detachable and re-attachable to said package, thereby allowing said package that has been folded and then rolled into a three-dimensional shape to reliably maintain said shape on a sorting conveyor. This embodiment is generally applicable when the product weighs more than 5 kg.

In this document, a three-dimensional shape is defined as one where the shortest dimension (e.g. circumference) is more than 10% of the length of the longest dimension (e.g. length).

Preferably, said three-dimensional shape is a scroll with a protruding lip that impedes rolling movement of said scrolled package. Compared with the prior art, the invention provides an improved ability to maintain a three-dimensional shape for a scrolled flexible package. In particular, it allows the package to be maintained in an incompletely scrolled configuration where the profile of the ‘scroll’ resembles a figure ‘six’ (or ‘nine’). This provides a partly non-cylindrical shape that prevents the pack from freely rolling on flat conveyor servicing a plastic sorting process, such as Near Infrared (NIR) scanners. This improves its ability to be reliably sorted into the correct plastic packaging stream.

Preferably said package has printed instructions, for attaching said tab to the package, that are revealed by lifting said tab from said pouch.

According to an alternative aspect of the invention, there is provided an adhesive web attachable to a part of a flexible package that is foldable or scrollable into a three-dimensional shape when substantially empty; said web being adapted to be deployed to enhance the ability of said package to remain in said three-dimensional shape; wherein said web is releasably adhesive to an outer surface of said package so that it lays flat on said surface; and wherein said web has one or more protruding tabs that may be lifted from contact with said surface and reattached to a different part of said package, while said first part of said web remains functionally integral with a second part of said web that remains attached to said surface. This alternative aspect is generally applicable when the product weighs less than 5 kg.

It is particularly preferred to use the web according to the invention on mono-polymer pouches, and where the web is made from the same polymer as the pouch. This provides a cleaner stream of material for recycling.

According to another aspect of the invention there is provided a flexible package incorporating an adhesive web according to any described above.

According to another aspect of the invention, there is provided the use of an adhesive web, according to any described above, to secure the three-dimensional shape of a folded or scrolled flexible package.

Now will be described, by way of specific, non-limiting examples, preferred embodiments of the invention with reference to the drawings.

### BRIEF DESCRIPTION OF THE DRAWINGS

FIG. 1 shows a flexible pouch package featuring an adhesive web according to the invention in an undeployed configuration.

FIG. 2 shows an adhesive web according to the invention in a partially deployed configuration.

FIG. 3 shows a flexible pouch package featuring an adhesive web according to the invention in a deployed configuration.

FIG. 4 shows an alternative view of a flexible pouch package featuring an adhesive web according to the invention in a deployed configuration.

FIG. 5 shows a flexible pouch package featuring an adhesive web according to an alternative embodiment of the invention in an undeployed configuration.

FIG. 6 shows the flexible pouch of FIG. 5 in a folded configuration.

FIG. 7 shows the flexible pouch and adhesive web of FIG. 5 in a deployed configuration.

### DETAILED DESCRIPTION OF THE INVENTION

The inventive concept is embodied in the design of an adhesive web that is applied to the outside wall of recyclable flexible packaging, such as a stand-up pouch, which enables the pouch, when emptied, to be rolled and maintained in a three-dimensional scrolled shape that is more readily detected and sorted using common waste sorting techniques, especially when discarded in a commingled or single stream collection system. For small to medium size pouches this three-dimensional shape preferably resembles a figure ‘six’ or ‘nine in profile. For larger pouches this may entail a folded and scrolled cylinder.

Examples of embodiments of the inventive concept are shown in the appended figures.

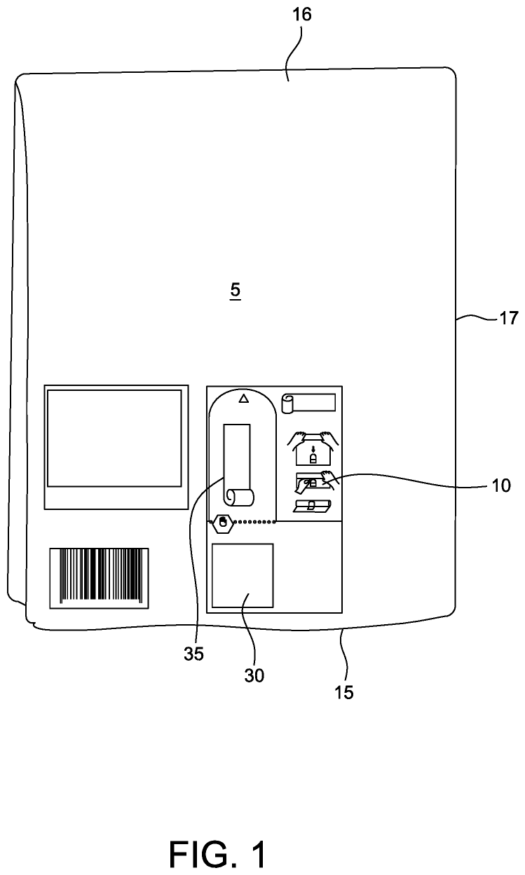

Example 1—Turning first to FIG. 1, there is shown a flexible stand-up pouch 5 for a food product, with an adhesive web 10 according to the invention attached centrally near the base edge 15 of the pouch 5. The web 10 adheres directly to the pouch 5. The web has a lower face 20 and an upper face 25.

The adhesive attaching the lower face 20 of the web 10 to the pouch 5 is preferably a 42N semi-permanent adhesive, such as Herma PW 517 White, supercalendered glassine, or equivalent.

The adhesive web is preferably made from the same polymer material as the pouch, as this obviates the need to separate the web from the pouch in the recycling process.

Suitable polymers for the pouch and web include, but are not limited to: polypropylene (PP), including, cast PP (CPP), oriented PP (OPP), biaxially orientated PP (BOPP); polyethylene (PE), including machine direction oriented (MDO-PE), biaxially orientated PE (BOPE), LDPE, HDPE; and polyester (PET).

Preferably the pouch is made from a single polymer material, as this makes the process of recovery and recycling much simpler.

The preferred pouch wall thickness for Polyolefin (PE & PP) should be at least 80 μm (micron).

The web 10 has two distinct sections. There is an anchor section 30 that is, in this example, located adjacent to the base edge 15 of the pouch 5, and a peelable tab 35 that attaches at a lower end to the anchor section 30. The tab 35 is contiguous with the anchor 30. It may be formed as part of, or the whole, width of the web 10.

The web may alternatively be placed near the top edge 16 or side edge 17 of the pouch 5.

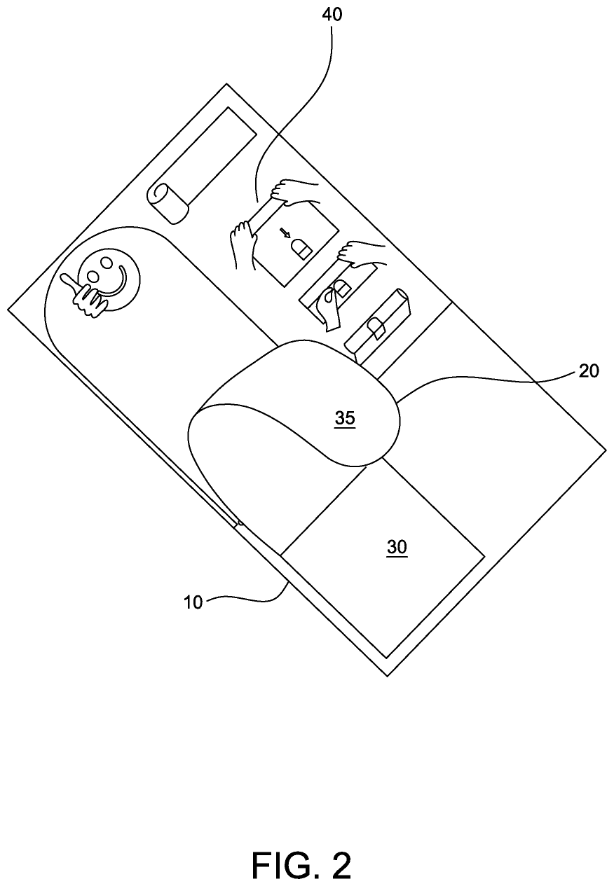

In FIG. 1, the web 10 is shown in an undeployed configuration. Turning to FIG. 2, there is shown the web 10 according to the invention in a partly deployed configuration. The peelable tab 35 has been lifted and peeled back from the pouch 5, the lifted area limited only to the tab 35 and not including the anchor section 30. The ‘next step’ user instructions 40 can be seen revealed printed on the pouch 10 itself once the tab 35 is lifted. The instruction drawings on the pouch artwork are supported by ‘reinforcing’ instructions in text that appear once the peelable tab is raised.

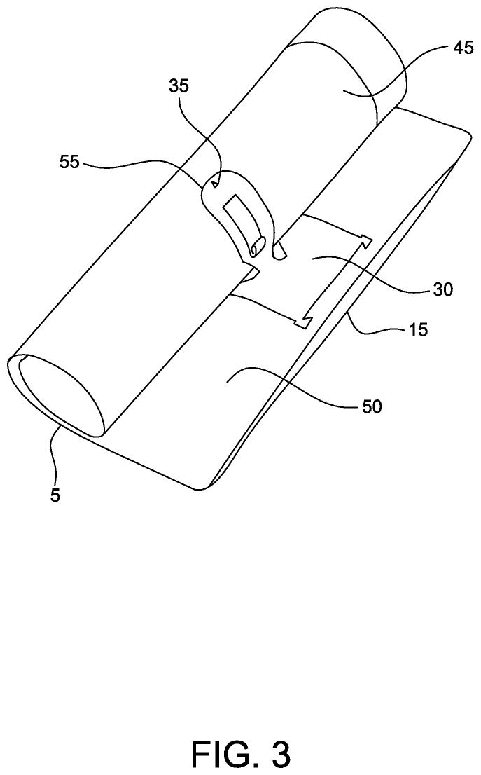

Turning to FIG. 3, the web is shown in a fully deployed configuration. The pouch 5 has been scrolled into a cylinder. The adhesive tab 35 has been attached to the pouch wall 45 in a position 55 that keeps the pouch scrolled, and allows a part 50 of the pouch 5 adjacent the lower edge 15 to remain flat. This section prevents excessive rolling of the pouch when it is on a flat conveyor passing e.g. an NIR scanner with automated physical sorting.

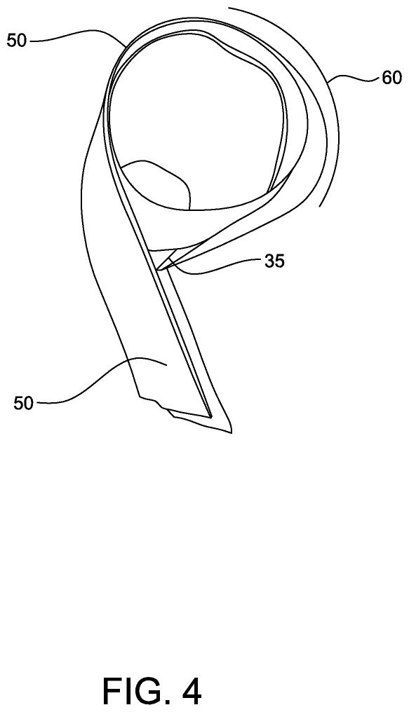

Turning to FIG. 4, the three-dimensional shape of the pouch, once the web has been deployed, is further illustrated. It can be seen that the profile of the pouch resembles a ‘six’ or a ‘nine’ as the tab 35 holds the scrolled position of the pouch in place and the flat section 55 protrudes from the scrolled section 60.

The invention is best deployed in pouches having a capacity of 5 kg or less. Larger pouches can also be scrolled using the web according to the alternative aspect of the invention defined above. This ensures the scrolled pouch is similar in size to the largest plastic bottles that are recoverable in an automated sorting facility.

It is also preferred that the shape of the package in the three-dimensional position is no bigger than 280 mm×90 mm (diameter) for best results.

The preferred size for the web in this example is 100 mm long×25 mm wide, with a minimum size of 60 mm long×20 mm wide for the smallest pouches. Approximately 40% of web length should be dedicated to being securely affixed to the packaging, with a marking indicating that the user should not peel the web off the package past the marked point.

Example 2—For larger pouches, e.g. for those with a capacity of greater than 5 kg, an alternative adhesive web design may be used. This is designed to reduce the length of the scrolled pouch to be similar to the largest plastic bottle that is recoverable by an automated sorting facility.

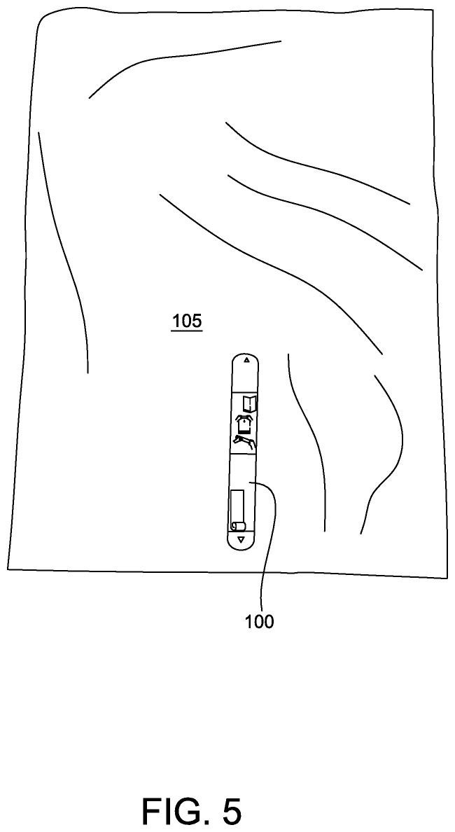

FIG. 5 shows this alternative web 100 attached to a larger pouch 105. This web 100 is removed fully by the consumer before application to secure a fully wound cylinder. It can be placed anywhere desired on the pouch 105.

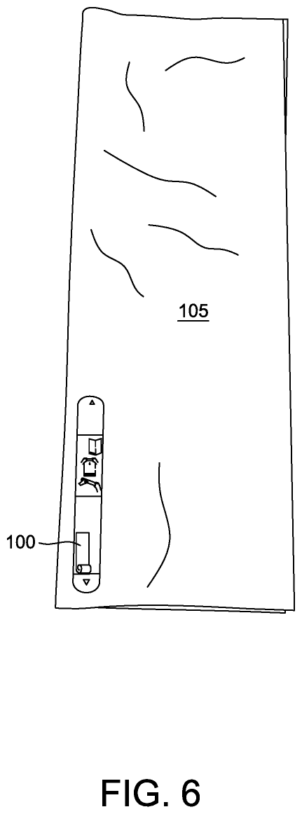

FIG. 6 shows the larger pouch 105 folded in half along its longest axis with the web 100 visible. The web is then fully removed and the pouch is scrolled along said longest axis.

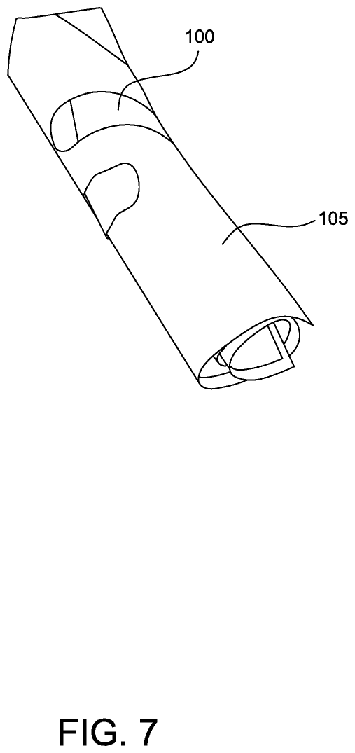

FIG. 7 shows the scrolled pouch 105 with the web 100 wrapped around the scroll in a spiral configuration, to securely keep the pouch 105 in a scrolled configuration.

Given the larger scrolled pouch's higher density, it is less likely to roll across the flat conveyor and so the flat section described in Example 1 is not as crucial.

In this example, the preferred web size is approximately 200 mm long×30 mm wide.

It is preferred that the web's visual designs incorporate pictorial instructions and minimal wording so that they can be understood by all consumers. For example, the visual design preferably includes a smiling face character and a positive message that is visible once the consumer is engaged and has pulled back the tab. This is essentially to thank them for playing the game.

The printed design on the web can also include e.g. a website URL so the consumers can access more information to substantiate the validity of the design via other information residing on the website.

Packages configured in ‘scrolled’ and ‘folded and scrolled’ configurations according to the above examples were combined with mixed waste including glass bottles, flattened paper and cardboard, and other waste materials that typically form part of unsorted recyclable municipal waste. These were then subjected to typical mixed waste sorting procedures utilising NIR-based sorting mechanisms. The results of the trial showed:

complete separation of the packages from the glass stream;

complete separation of the packages from the corrugated cardboard stream; and

almost complete separation of the pouches from the mixed paper stream for pouched that remained rolled

the vast majority of the packages ended in the mixed plastics stream as desired.

This represents a significant improvement on the results that would be expected had the packaged been placed in a flattened state in the sorting process, where a large proportion of the packages would typically end in the mixed paper and corrugated cardboard streams.

It will be appreciated by those skilled in the art that the above-described embodiment is merely one example of how the inventive concept can be implemented. It will be understood that other embodiments may be conceived that, while differing in their detail, nevertheless fall within the same inventive concept and represent the same invention.

1. An adhesive web attachable to a part of a flexible package that is foldable or scrollable into a three-dimensional shape when substantially empty; said web being adapted to be deployed to enhance the ability of said package to remain in said three-dimensional shape; wherein said web is releasably adhesive to an outer surface of said package so that it lays flat on said surface; and wherein said web has one or more protruding tabs that may be lifted from contact with said surface and reattached to a different part of said package, while said first part of said web remains functionally integral with a second part of said web that remains attached to said surface.

2. An adhesive web attachable to a part of a flexible package adapted to hold greater than 5 kg of product and that is both foldable and scrollable into a three-dimensional shape when substantially empty; said web being adapted to be deployed to enhance the ability of said package to remain in said three-dimensional shape; wherein said web is wholly detachable and re-attachable to said package, thereby allowing said package that has been folded and then rolled into a three-dimensional shape to reliably maintain said shape on a sorting conveyor.

3. An adhesive web according to claim 1, wherein said three-dimensional shape is a scroll with a protruding lip that impedes rolling movement of said scrolled package.

4. An adhesive web according to claim 1, wherein said package has printed instructions, for attaching said tab to the package, that are revealed by lifting said tab from said pouch.

5. An adhesive web according to claim 2, wherein said package has printed instructions, for attaching said tab to the package, that are revealed by lifting said tab from said pouch.

6. A flexible package incorporating an adhesive web according to claim 1.

7. A flexible package incorporating an adhesive web according to claim 2.

8. The flexible package of claim 6, wherein said package has printed instructions, for attaching said tab to the package, that are revealed by lifting said tab from said pouch.

9. The flexible package of claim 7, wherein said package has printed instructions, for attaching said tab to the package, that are revealed by lifting said tab from said pouch.

10. The use of an adhesive web according to claim 1, to secure the three-dimensional shape of a folded or scrolled flexible package.

11. The use of an adhesive web according to claim 2, to secure the three-dimensional shape of a folded or scrolled flexible package.

12. The method of claim 10, wherein said three-dimensional shape of said package is a scroll with a protruding lip that impedes rolling movement of said scrolled package.

13. The method of claim 11, wherein said three-dimensional shape of said package is a scroll with a protruding lip that impedes rolling movement of said scrolled package.
